(19) United States
(12) Patent Application Publication
(10) Pub. No.: US 2011/0085861 A1
(43) Pub. Date: Apr. 14, 2011

(54) Grouting device

(75) Inventors: Neville Jukes, Rathmines (AU); Brian Woolnough, Toronto (AU)

(73) Assignee: Hilti Aktiengesellschaft, Schaan (LI)

(21) Appl. No.: 12/807,977

(22) Filed: Sep. 17, 2010

(30) Foreign Application Priority Data
Sep. 18, 2009 (AU) AU 2009904573

(51) Int. Cl. E02D 5/80; B05C 17/00

(52) U.S. Cl. 405/302.2; 222/173

(57) ABSTRACT

A grout applicator including a grout tube adapted to detachably connect to a strata support cable or tendon, or a tensioning device associated therewith, for grouting an annulus between an elongate rock cavity and the support cable or tendon, the grout tube having a grout passageway in fluid communication with the annulus; and a clamp member movably coupled to the grout tube for clamping of the grout tube to the support cable or tendon, or the tensioning device, whereby in operation grout is injected into the annulus via the grout tube.

This claims the benefit of Australian Patent Application AU 2009904573, filed Sep. 18, 2009 and hereby incorporated by reference herein.

### FIELD OF THE INVENTION

The present invention relates broadly to a grout applicator and a sealing assembly for a strata support cable or tendon.

### BACKGROUND

In underground mining and strata control, bolting is generally recognized as the primary support system. Bolting usually involves grouting of a rock bolt within a bolt hole formed in the strata of an underground mine. The bolt is initially anchored at the end of the bolt hole using a resin or fast-setting grout and then tensioned so that the strata surrounding the bolthole is held in compression. This technique has been extended to cables or tendons where generally a barrel and wedge fitting is attached to the cable and is tensioned using hydraulically actuated equipment.

The typical practice for post-grouting the tensioned cable or tendon to achieve full encapsulation involves:

Clamping or clipping an air return tube or hose along the length of the cable or tendon;

Filling the annulus space surrounding the cable or tendon with grout from the bottom up and venting air from the enclosed upper space of the hole via the air return tube or hose.

Alternatively, top down grouting is used where the grout is pumped up a central tube and the air is displaced down the annulus between the cable and the borehole wall.

The grout is typically pumped into the hole via a port provided in a strata plate which surrounds the opening to the hole or through a tube inside the cable.

### SUMMARY OF THE INVENTION

It is an object of the present invention to provide a grout applicator comprising:

a. a grout tube adapted to detachably connect to a strata support cable or tendon, or a tensioning device associated therewith, for grouting an annulus between an elongate rock cavity and the support cable or tendon, the grout tube having a grout passageway in fluid communication with the annulus; and

b. a clamp member movably coupled to the grout tube for clamping of the grout tube to the support cable or tendon, or the tensioning device, whereby in operation grout is injected into the annulus via the grout tube.

Preferably the grout applicator also comprises a grout manifold connected to an end of the grout tube and having a manifold passageway for fluid communication between the grout passageway of the grout tube and the annulus. More preferably the grout manifold includes a grout nozzle defining part of the manifold passageway and arranged for mating contact with the tensioning device associated with the support cable or tendon. Even more preferably the grout nozzle sealingly engages a grout port in a barrel fitting of the tensioning device.

Preferably the clamp member includes a clamp arm pivotally coupled to the grout manifold. More preferably the clamp member also includes an overcenter cam connected to an end of the clamp arm and arranged for detachable clamping of the grout tube to the tensioning device. Even more preferably the grout manifold includes a locating member configured to locate against the tensioning device for alignment of the grout nozzle with the grout port on pivotal movement of the clamp member for clamping of the grout tube.

Preferably the grout tube is a rigid tube detachably connected to the grout manifold. More preferably the rigid grout tube is selected from one of a plurality of grout tubes of different lengths. Even more preferably the clamp arm is likewise selected from one of a plurality of clamp arms of different lengths corresponding to the plurality of grout tubes.

Preferably the grout applicator further comprises a locking member located intermediate the grout tube and the clamp arm for retaining the grout tube in clamped engagement with the grout tube. More preferably the locking member includes a rigid locking arm at one end movably connected to the clamp arm and at an opposite end being configured to latch the grout tube, or vice versa.

According to another aspect of the invention there is provided a sealing assembly for a strata support cable or tendon, the sealing assembly comprising:

a. a tubular housing adapted to locate within an annulus between an elongate rock cavity and the support cable or tendon at or adjacent an opening of the rock cavity; and

b. one or more sealing elements connected to and radially extending from the tubular housing, said sealing elements being adapted to at least in part contact a perimeter wall of the rock cavity at or adjacent its opening thereby reducing leakage of grout from the annulus via the rock opening.

Preferably the tubular housing is adapted to co-operate with a tensioning device associated with the cable or tendon. More preferably the tubular housing slidably fits about the tensioning device. Alternatively, the tubular housing includes an internal thread arranged to threadably engage a corresponding external thread of a barrel of the tensioning device.

Preferably the one or more sealing elements are in the form of a plurality of longitudinally spaced and radially extending ribs. More preferably each of the ribs are cup-shaped and constructed of a resilient flexible material.

Preferably the sealing assembly is one of a plurality of said assemblies each threaded internally and externally at their respective opposing ends. More preferably the plurality of sealing assemblies is screw connected end to end. Even more preferably the sealing assembly is located within a counter-bore of the rock cavity at the opening of the rock cavity.

Generally the tubular housing and sealing elements are formed integral with one another.

Grout is to be understood as including resin.

### BRIEF DESCRIPTION OF THE DRAWINGS

In order to achieve a better understanding of the nature of the present invention a preferred embodiment of a grout applicator and a sealing assembling for a strata support cable or tendon will now be described, by way of example only, with reference to the accompanying drawings in which:

FIG. 1 is a perspective view of a grout applicator of one embodiment of the present invention in conjunction with a tensioning device and a sealing assembly for a strata support cable or tendon;

FIG. 2 is an exploded perspective view of the grout applicator, tensioning device, and sealing assembly of FIG. 1; and

FIG. 3 is a perspective view of a variant of the grout applicator of the embodiment of FIGS. 1 and 2.

### DETAILED DESCRIPTION

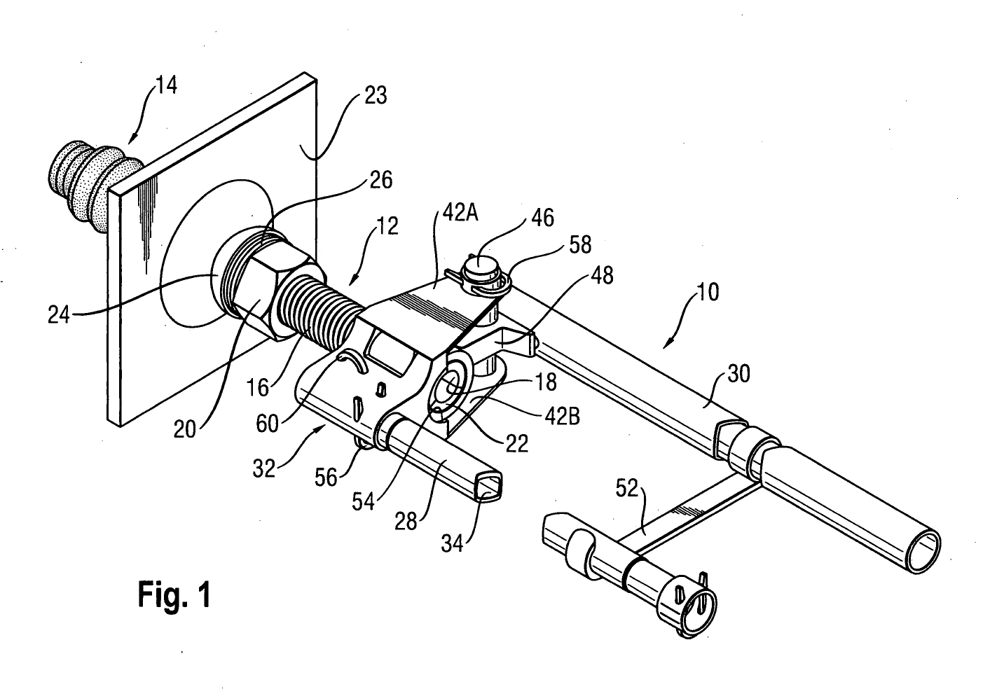

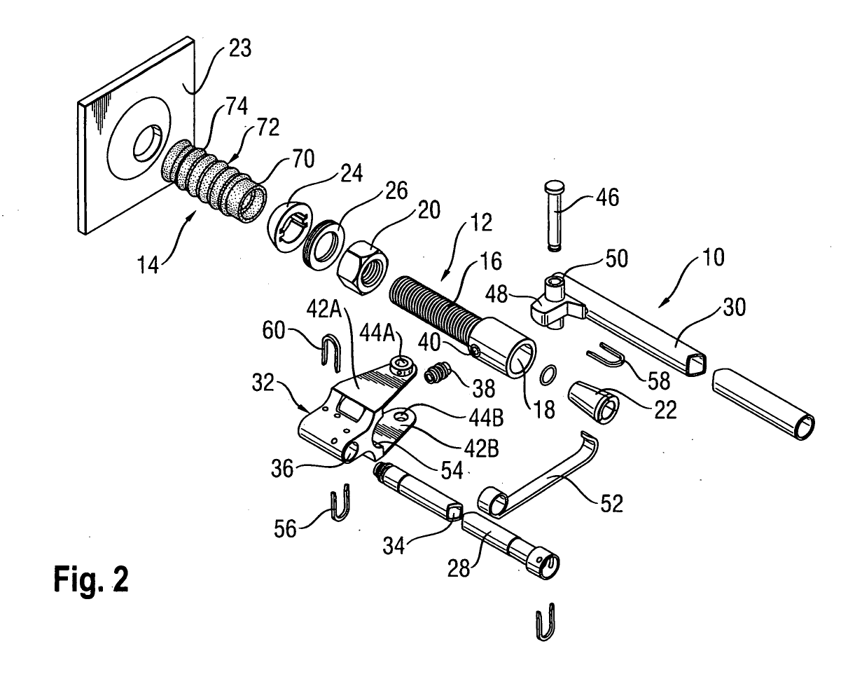

As shown in FIGS. 1 and 2 there is a grout applicator 10 together with a tensioning device 12 and associated sealing assembly 14 for a strata support cable or tendon (not shown).

The tensioning device 12 is of a similar construction to that described in International Patent Application No. PCT/AU2008/001423, which is hereby incorporated by reference herein. The tensioning device 12 includes a tensioning member or barrel 16 which has a central elongate bore 18 adapted to receive the strata support cable. The barrel 16 is partly threaded along its length for engagement with a nut 20. The tensioning device 12 also includes a wedge assembly 22 for securing the cable or tendon to the threaded barrel 16. The cable or tendon is tensioned by rotating the nut 20 around the threaded barrel 16 which drives a strata or volcano plate 23 against the strata via an intermediate domed washer 24 and bearing assembly 26.

Operation and construction of the tensioning device 12 is otherwise described in some detail in International Patent Application No. PCT/AU2007/01141, which is hereby incorporated by reference herein.

The grout applicator 10 of this aspect of the invention is used to grout an annulus between an elongate rock cavity and the support cable or tendon. This grouting is preferably performed as a post-grouting step once the cable or tendon has been anchored and tensioned within the elongate cavity using the tensioning device 12. The grout is preferably a thixotropic grout or resin injected into the elongate cavity of the strata or geological structure surrounding the cable or tendon.

The grout applicator 10 of this example is arranged to detachably connect to the tensioning device 12. The grout applicator 10 includes a grout tube 28 which is in this embodiment pivotally coupled to a clamp member 30 via an intermediate grout manifold 32. The grout tube 28 has a grout passageway 34 which is in fluid communication with a manifold passageway 36 for the supply of grout to the borehole annulus via the tensioning device 12.

The grout manifold 32 includes a grout nozzle 38 (FIG. 2) forming a discharge end of the manifold passageway 36 and being arranged for making contact with the threaded barrel 16. In this embodiment the grout nozzle 38 sealingly engages a grout port 40 in the barrel fitting 16 of the tensioning device 12.

As best shown in FIG. 1 the grout manifold 32 includes a pair of laterally spaced apart manifold plates 42A and 42B which in operation will locate either side of the barrel fitting 16. Each of the manifold plates 42A/B includes a shaft opening 44A/B (FIG. 2) through which a pivot shaft 46 locates. The pivot shaft 46 pivotally connects the clamp member or arm 30 to the grout manifold 32 for clamping about the barrel fitting 16. The clamp arm 30 includes an over center cam 48 and an associated journal element 50 through which the pivot shaft 46 passes. The over center cam 48 is designed to maintain clamping of the grout tube 28 and the associated manifold 32 to the barrel fitting 16 of this embodiment.

The grout applicator 10 in this embodiment also comprises a locking member in the form of a rigid locking arm 52 at one end hinged about the clamp arm 30 and at an opposite end configured to latch the grout tube 28. The applicator 10 therefore relies on the combination of the rigid locking arm 52 and the clamping action of the over centre cam 48 to safely retain the applicator on the barrel fitting 16 of the tensioning device 12. The grout manifold 32 also includes a locating member or flange 54 located intermediate the manifold plates 42A/B and configured to locate against a lower face of the barrel fitting 16 for alignment of the grout nozzle 38 with the grout port 40.

In this embodiment both the grout tube 28 and the clamp arm 30 are constructed of a rigid material, such as mild steel. This allows for overhead manipulation of the applicator 10 onto the tensioning device 12 which is elevated depending on the height of the coal seam. The grout tube 28 is detachably connected to the grout manifold 32 via the grout passageway 36. The grout tube 28 can be selected from a plurality of grout tubes of different lengths depending on the height of the coal seam and thus the required reach of the applicator 10 to the overhead tensioning device 12. The clamp arm 30 may likewise be selected from one of a plurality of clamp arms of different lengths corresponding to the selected grout tube 28. Both the grout tube 28 and the clamp arm 30 are in this example detachably connected to the grout manifold 32 for quick release and separation using respective circlips 56 and 58. The grout nozzle 38 is likewise connected to the grout manifold 32 for quick release using circlip 60.

The sealing assembly 14 of another aspect of the invention is used in conjunction with the strata support cable or tendon for reducing leakage of grout from the associated rock bore annulus. In this embodiment the sealing assembly 14 comprises a tubular housing 70 together with one or more sealing elements shown generally as 72 connected to and radially extending from the tubular housing 70. The borehole annulus is formed between an elongate rock cavity and the support cable or tendon at or adjacent an opening of the rock cavity.

The tubular housing of this example is adapted to threadably fit about the barrel 16 of the tensioning device 12. The tubular housing 70 may alternatively be slidably fitted to the barrel 16. The sealing elements 72 are each formed as cup-shaped ribs such as 74 equally spaced longitudinally along the tubular housing 70. The cup-shaped ribs 74 are constructed of a resiliently flexibly material which deforms within to form a seal about the borehole annulus.

The sealing assembly 14 may include a single tubular housing such as 70 or multiple tubular housings 70 connected end to end. In the case of multiple sealing assemblies 14 the tubular element such as 70 is threaded internally and externally at its respective opposing ends. The sealing assembly 14 is generally formed in one piece with the tubular housing 70 and the sealing elements 72 formed integral with one another.

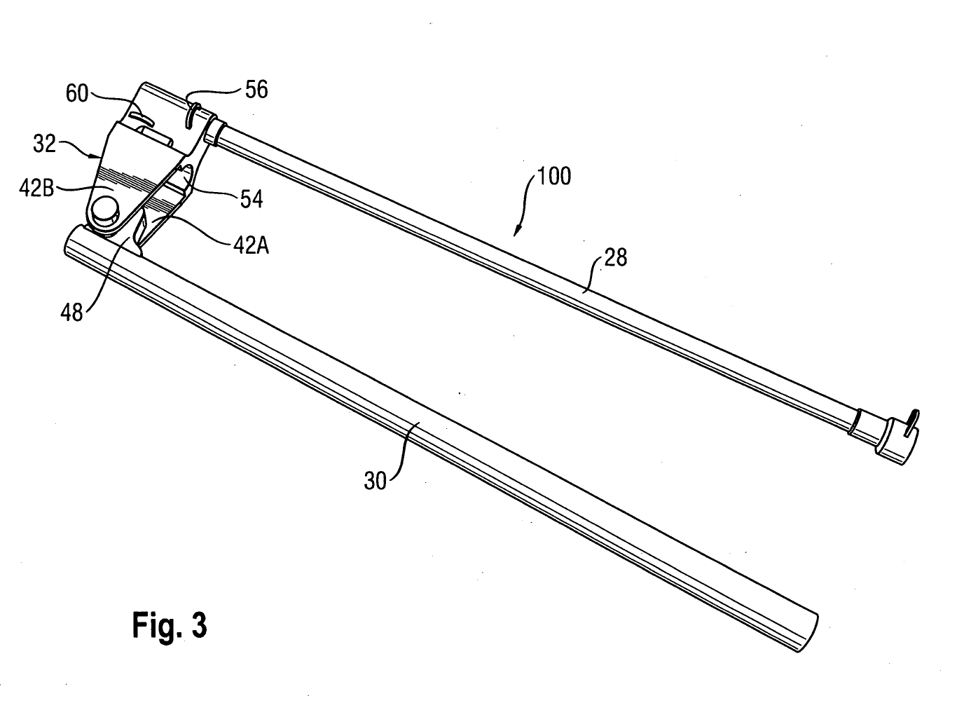

As shown in FIG. 3 there is a variation on the grout applicator 10 of the previous embodiment. For ease of reference and in order to avoid repetition the more fundamental components of this alternate grout applicator 100 have been designated with the same corresponding reference numerals to the previous embodiment. The grout applicator 100 is effectively the same as the previous grout applicator 10 but relies solely upon the over centre cam 48 for retention on the tensioning device 12 without the locking or latch arm 52.

In order to facilitate a further understanding of the invention in its various aspects, operation of the grout applicator 10 in conjunction with the sealing assembly 14 of the described embodiments will now be explained. The general steps involved in installation and tensioning of a strata support cable or tendon using the grout applicator 10 and the sealing assembly 14 are as follows:

The strata support cable is installed and tensioned in a bolthole as described in the background to the invention;

The sealing assembly 14 is located within a counter-bore of the borehole at its opening in the course of installing the strata support cable or tendon together with the tensioning device such as 12 under the preceding step;

The grout applicator 10 is clamped to the barrel 16 of the tensioning device 12 utilising the grout tube 28 in conjunction with the clamp arm 30;

Grout or resin is pumped into the rock bolt annulus via a flexible hose detachably connected to the grout tube 28;

Once the post-grouting of the preceding step is complete the grout applicator 10 is released from the tensioning device 12.

The clamping of the grout applicator 10 to the tensioning device in step 3 is facilitated by at least the following design features of the grout applicator 10:

The rigid and elongate grout tube 28 and clamp arm 30 permitting movement and location of the grout manifold 32 into overhead clamping engagement with the barrel 16 of the tensioning device 12;

The locating member or flange 54 of the grout manifold 32 vertically abuts with the barrel 16 for longitudinal location of the grout nozzle 38 with the grout port 40 in the barrel fitting 16;

The over center cam 48 either alone or together with the latching arm 52 provides for secure and safe clamping of the applicator 10 to the barrel 16.

Now that several preferred embodiments of the present invention have been described in some detail it will be apparent to those skilled in the art that the grout applicator and sealing assembly for a strata support cable or tendon have at least the following advantages:

The grout applicator provides for a relatively quick and safe post-grouting operation;

The grout applicator is modular in construction whereby it can be broken down for ease of cleaning;

The grout applicator can be adapted to rock seams and other applications of different heights using for example grout tubes and clamp arms of different lengths;

The sealing assembly reduces leakage from the borehole opening during for example post-grouting.

Those skilled in the art will appreciate that the invention described herein is susceptible to variations and modifications other than those specifically described. For example, the grout applicator may clamp directly to the strata support cable or tendon rather than the tensioning device as described. The specific construction of the grout applicator may vary from that described where for example the grout tube itself provides direct and detachable clamping without an intermediate grout manifold. All such variations and modifications are to be considered within the scope of the present invention the nature of which is to be determined from the foregoing description.

What is claimed is:

1. A grout applicator comprising:
a grout tube adapted to detachably connect to a strata support cable or tendon, or to a tensioning device associated with the strata support cable or tendon, for grouting an annulus between an elongate rock cavity and the support cable or tendon, the grout tube having a grout passageway in fluid communication with the annulus; and
a clamp member movably coupled to the grout tube for clamping of the grout tube to the support cable or tendon, or to the tensioning device, grout during operation being injected into the annulus via the grout tube.

2. The grout applicator as recited in claim 1 further comprising a grout manifold connected to an end of the grout tube and having a manifold passageway for fluid communication between the grout passageway of the grout tube and the annulus.

3. The grout applicator as recited in claim 2 wherein the grout manifold includes a grout nozzle defining part of the manifold passageway and arranged for mating contact with the tensioning device associated with the support cable or tendon.

4. The grout applicator as recited in claim 3 wherein the grout nozzle sealingly engages a grout port in a barrel fitting of the tensioning device.

5. The grout applicator as recited in claim 2 wherein the clamp member includes a clamp arm pivotally coupled to the grout manifold.

6. The grout applicator as recited in claim 5 wherein the clamp member includes an overcenter cam connected to an end of the clamp arm and arranged for detachable clamping of the grout tube to the tensioning device.

7. The grout applicator as recited in claim 4 wherein the grout manifold includes a locating member configured to locate against the tensioning device for alignment of the grout nozzle with the grout port on pivotal movement of the clamp member for clamping of the grout tube.

8. The grout applicator as recited in claim 2 wherein the grout tube is a rigid tube detachably connected to the grout manifold.

9. The grout applicator as recited in claim 8 wherein the rigid grout tube is selected from one of a plurality of grout tubes of different lengths.

10. The grout applicator as recited in claim 5 wherein the clamp arm is selected from one of a plurality of clamp arms of different lengths corresponding to the plurality of grout tubes.

11. The grout applicator as recited in claim 5 further comprising a locking member located intermediate the grout tube and the clamp arm for retaining the grout tube in clamped engagement with the clamp arm.

12. The grout applicator as recited in claim 11 wherein the locking member includes a rigid locking arm at one end movably connected to the clamp arm and at an opposite end being configured to latch the grout tube, or vice versa.

13. A sealing assembly for a strata support cable or tendon, the sealing assembly comprising:
a tubular housing adapted to locate within an annulus between an elongate rock cavity and the support cable or tendon at or adjacent an opening of the rock cavity; and
at least one sealing element connected to and radially extending from the tubular housing, the sealing element being adapted to at least in part contact a perimeter wall of the rock cavity at or adjacent the opening thereby reducing leakage of grout from the annulus via the opening.

14. The sealing assembly as recited in claim 13 wherein the tubular housing is adapted to co-operate with a tensioning device associated with the cable or tendon.

15. The sealing assembly as recited in claim 14 wherein the tubular housing slidably fits about the tensioning device.

16. The sealing assembly as recited in claim 14 wherein the tubular housing includes an internal thread arranged to threadably engage a corresponding external thread of a barrel of the tensioning device.

17. The sealing assembly as recited in claim 13 wherein the one or more sealing elements are in the form of a plurality of longitudinally spaced and radially extending ribs.

18. The sealing assembly as recited in claim 17 wherein each of the ribs are cup-shaped and constructed of a resilient flexible material.

19. The sealing assembly as recited in claim 13 wherein the sealing assembly is one of a plurality of said assemblies each threaded internally and externally at their respective opposing ends.

20. The sealing assembly as recited in claim 19 wherein the plurality of sealing assemblies are screw connected end to end.

21. The sealing assembly as recited in claim 13 wherein the sealing assembly is located within a counter-bore of the rock cavity at the opening of the rock cavity.

22. The sealing assembly as recited in claim 13 wherein the tubular housing and sealing elements are formed integrally with one another.

23. A method for operating the grout applicator as recited in claim 1 comprising injecting grout during operation into the annulus via the grout tube.
